(19) United States
(12) Patent Application Publication
(10) Pub. No.: US 2021/0304989 A1
(43) Pub. Date: Sep. 30, 2021

(54) SENSOR SWITCH

(71) Applicant: Tien-Ming CHOU, Taichung City (TW)

(72) Inventor: Tien-Ming CHOU, Taichung City (TW)

(21) Appl. No.: 17/086,892

(22) Filed: Nov. 2, 2020

(30) Foreign Application Priority Data
Mar. 27, 2020 (TW) 109110581

(51) Int. Cl. H01H 35/02; G01C 9/06

(52) U.S. Cl. CPC H01H 35/02; G01C 9/06; H01H 2203/026; G01C 2009/068; H01H 2229/066; H01H 2229/056; H01H 2203/056

(57) ABSTRACT

A sensor switch includes a ceramic body, first and second conductive units and a conductive member. The ceramic body includes intermediate, bottom and top layer assemblies cooperatively defining a chamber. The intermediate layer assembly has an intermediate layer inner peripheral surface. The bottom layer assembly has a bottom groove communicating with the chamber. The first conductive unit has a first conductive layer covering the intermediate layer inner peripheral surface. The second conductive unit has at least one second conductive layer disposed in the bottom groove. The conductive member is rollably disposed in the chamber for forming a current path with the first and second conductive layers.

### CROSS REFERENCE TO RELATED APPLICATION

This application claims priority of Taiwanese Patent Application Number 109110581, filed on Mar. 27, 2020.

### FIELD

The disclosure relates to a switch device, more particularly to a sensor switch.

### BACKGROUND

An existing rolling ball sensor switch is configured to be disposed on a circuit board, and uses a rolling ball therein to sense the angle change and then transmit the sensed result to the circuit board. Thus, the rolling ball sensor switch can be used in security alarm devices, anti-theft devices, toys, etc. However, the existing rolling ball sensor switch has many components that occupy a substantial space so that it is difficult to reduce the size thereof.

### SUMMARY

Therefore, an object of the present disclosure is to provide a sensor switch that can alleviate at least one of the drawbacks of the prior art.

According to this disclosure, a sensor switch comprises a ceramic body, first and second conductive units, and a conductive member. The ceramic body is made from a plurality of raw ceramic blanks that are sintered after being stacked, and includes an intermediate layer assembly, a bottom layer assembly disposed on a bottom portion of the intermediate layer assembly, and a top layer assembly disposed on a top portion of the intermediate layer assembly and opposite to the bottom layer assembly. The intermediate layer assembly, the bottom layer assembly and the top layer assembly cooperatively define a chamber. The intermediate layer assembly has an intermediate layer inner peripheral surface facing the chamber, and an intermediate layer outer peripheral surface opposite to the intermediate layer inner peripheral surface. The bottom layer assembly has a bottom layer top surface connected to the bottom portion of the intermediate layer assembly and facing the chamber, a bottom groove indented inwardly from the bottom layer top surface and communicating with the chamber, and a bottom layer outer peripheral surface connected to an outer periphery of the bottom layer top surface.

The first conductive unit is made of metal and includes a first conductive layer disposed on and covering the intermediate layer inner peripheral surface, and at least one first internal circuit connected to the first conductive layer and extending from the first conductive layer to the intermediate layer outer peripheral surface.

The second conductive unit is made of metal and includes at least one second conductive layer disposed in the bottom groove, and at least one second internal circuit connected to the second conductive layer and extending from the second conductive layer to the bottom layer outer peripheral surface.

The conductive member is rollably disposed in the chamber and is movable between a first closed circuit position and an open circuit position. When the conductive member is in the first closed circuit position, the first conductive layer, the conductive member and the second conductive layer form a current path. When the conductive member is in the open circuit position, the first conductive layer, the conductive member and the second conductive layer do not form a current path. When the ceramic body is placed in a normal and horizontal position, in which the bottom layer assembly, the intermediate layer assembly and the top layer assembly are arranged in a bottom-to-top direction, the conductive member is limited by the second conductive layer and is positioned at the open circuit position.

### BRIEF DESCRIPTION OF THE DRAWINGS

Other features and advantages of the disclosure will become apparent in the following detailed description of the embodiments with reference to the accompanying drawings, of which:

FIG. 1 is a perspective view of a sensor switch according to the first embodiment of the present disclosure;

FIG. 2 is a schematic top view of the first embodiment;

FIG. 3 is a sectional view of the first embodiment taken along line III-III of FIG. 2;

FIG. 4 is a sectional view of the first embodiment taken along line IV-IV of FIG. 2;

FIG. 5 is a sectional view of the first embodiment taken along line V-V of FIG. 2, illustrating how a conductive member is movable between an open circuit position and a first closed circuit position;

FIG. 6 is a sectional view of the first embodiment, illustrating a conductive member in a second closed circuit position;

FIG. 7 is an exploded perspective view of the first embodiment;

FIG. 8 is a sectional view of a sensor switch according to the second embodiment of the present disclosure;

FIG. 9 is a sectional view of the second embodiment taken along line IX-IX of FIG. 8;

FIG. 10 is a sectional view of a sensor switch according to the third embodiment of the present disclosure;

FIG. 11 is a perspective view of a sensor switch according to the fourth embodiment of the present disclosure;

FIG. 12 is a schematic top view of the fourth embodiment;

FIG. 13 is a sectional view of the fourth embodiment taken along line XIII-XIII of FIG. 12;

FIG. 14 is a sectional view of the fourth embodiment taken along line XIV-XIV of FIG. 12;

FIG. 15 is a sectional view of the fourth embodiment taken along line XV-XV of FIG. 12;

FIG. 16 is a view similar to FIG. 15, but illustrating a ceramic body in an upside down and horizontal position; and

FIG. 17 is an exploded perspective view of the fourth embodiment.

### DETAILED DESCRIPTION

Before the present disclosure is described in greater detail with reference to the accompanying embodiments, it should be noted herein that like elements are denoted by the same reference numerals throughout the disclosure.

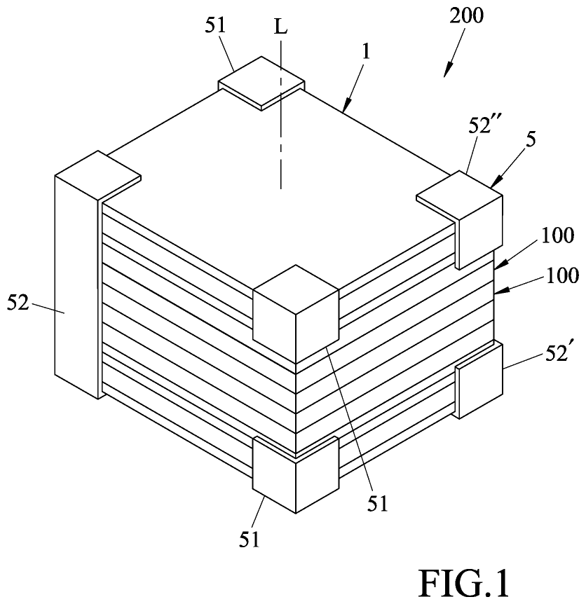

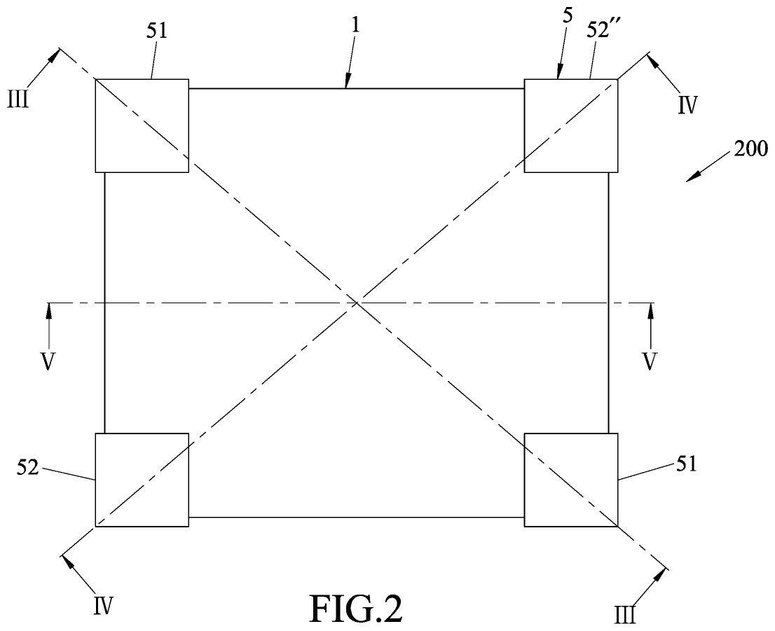

Referring to FIGS. 1 to 7, a sensor switch 200 according to the first embodiment of the present disclosure is suitable for connection with a circuit board (not shown), and includes a ceramic body 1, a first conductive unit 2, a second conductive unit 3, a third conductive unit 4, an external electrode unit 5, and a conductive member 6.

The ceramic body 1 is made from a plurality of raw ceramic blanks 100 that are sintered after being stacked. The ceramic body 1 has a rectangular shape, and includes an intermediate layer assembly 11, a bottom layer assembly 12 disposed on a bottom portion of the intermediate layer assembly 11, and a top layer assembly 13 disposed on a top portion of the intermediate layer assembly 11 and opposite to the bottom layer assembly 12. The bottom layer assembly 12, the intermediate layer assembly 11 and the top layer assembly 13 are normally arranged in a bottom-to-top direction, and cooperatively define a chamber 10. The chamber 24 has an axis (L) parallel to the bottom-to-top direction.

The intermediate layer assembly 11 has an intermediate layer inner peripheral surface 111 facing the chamber 24, and an intermediate layer outer peripheral surface 112 opposite to the intermediate layer inner peripheral surface 111.

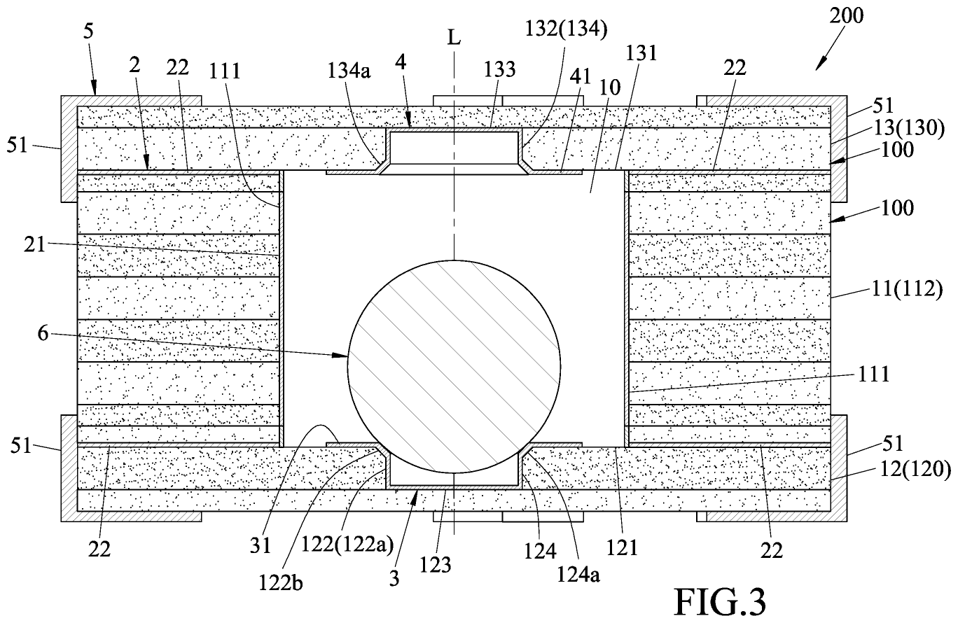

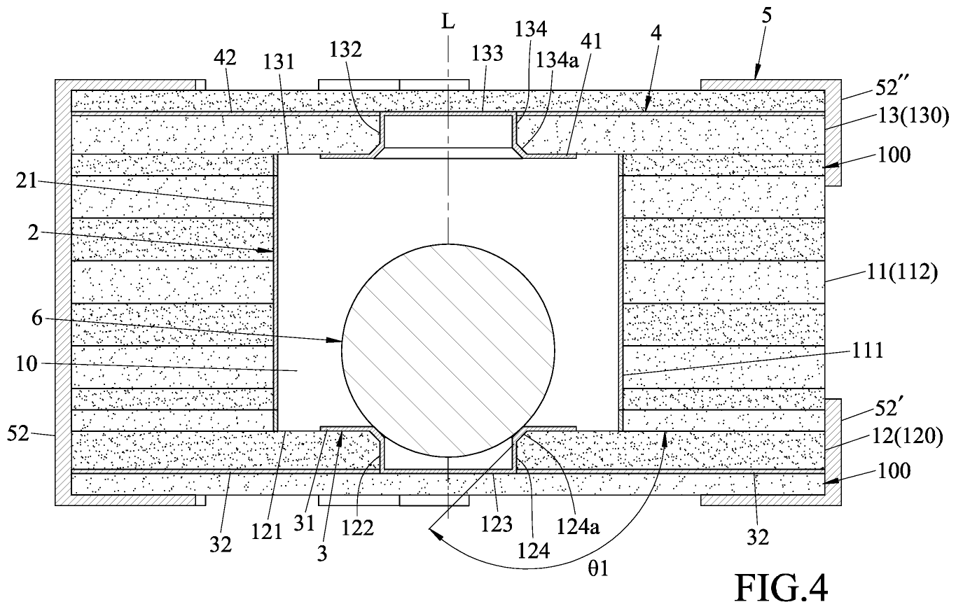

The bottom layer assembly 12 has a bottom layer top surface 121 connected to the bottom portion of the intermediate layer assembly 11 and facing the chamber 10, a bottom groove 124 indented inwardly from the bottom layer top surface 121 and communicating with the chamber 10, and a bottom layer outer peripheral surface 120 connected to an outer periphery of the bottom layer top surface 121. As shown in FIG. 3, the bottom groove 124 is defined by a groove surrounding wall 122 connected to the bottom layer top surface 121, and a groove bottom wall 123 connected to the groove surrounding wall 122 opposite the bottom layer top surface 121. The outline of the bottom groove 124 perpendicular to the axis (L) is circular. The bottom groove 124 has an open end (124a) communicating with the chamber 10. The groove surrounding wall 122 has a perpendicular portion (122a) perpendicularly connected to a periphery of the bottom groove wall 123, and a chamfered portion (122b) connected between the perpendicular portion (122a) and the bottom layer top surface 121. In this embodiment, the chamfered portion (122b) and the bottom layer top surface 121 define an included angle (θ1) therebetween, as shown in FIG. 4. The included angle (θ1) is an obtuse angle.

The top layer assembly 13 has a top layer bottom surface 131 connected to the top portion of the intermediate layer assembly 11 and facing the chamber 10, a top groove 134 indented inwardly from the top layer bottom surface 131, and a top layer outer peripheral surface 130 connected to an outer periphery of the top layer bottom surface 131. With reference to FIG. 3, the top groove 134 is defined by a groove surrounding wall 132 connected to the top layer bottom surface 131, and a groove bottom wall 133 connected to the groove surrounding wall 132 opposite the top layer bottom surface 131. The top groove 134 has an open end (134a). In this embodiment, the top layer assembly 13 has a structure symmetrical to that of the bottom layer assembly 12, so that a detailed description thereof is omitted herein.

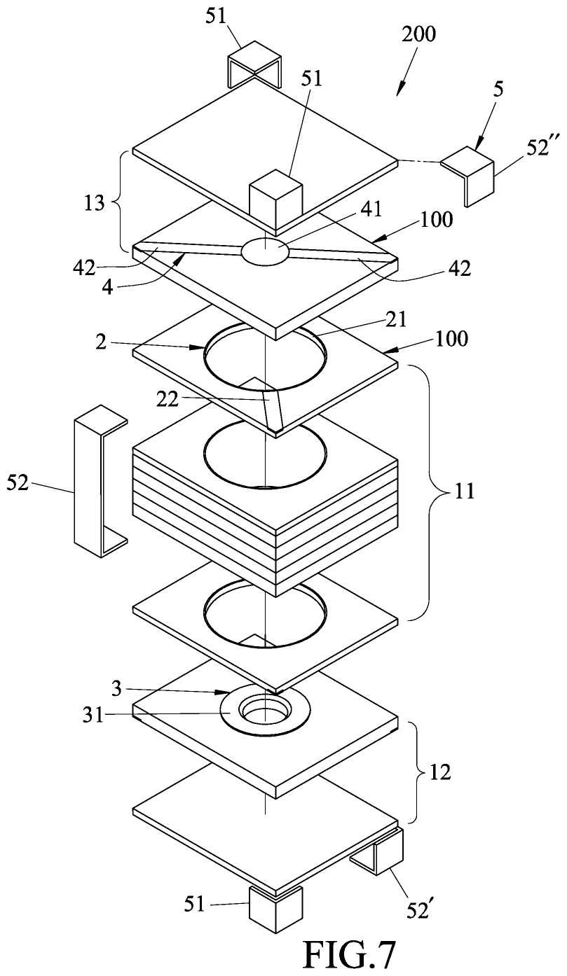

With reference to FIG. 7, in this embodiment, the bottom layer assembly 12 includes two raw ceramic blanks 100, the intermediate layer assembly 11 includes eight raw ceramic blanks 100, and the top layer assembly 13 includes two raw ceramic blanks 100. However, the number of the raw ceramic blanks 100 of each of the bottom layer assembly 12, the intermediate layer assembly 11 and the top layer assembly 13 is not limited to what is disclosed herein.

The first conductive unit 2 is made of metal, and includes a first conductive layer 21 disposed on and covering the intermediate layer inner peripheral surface 111, and at least one first internal circuit 22 connected to the first conductive layer 21 and extending from the first conductive layer 21 to the intermediate layer outer peripheral surface 112. In this embodiment, the first conductive unit 2 includes four first internal circuits 22 connected to the first conductive layer 21 and extending from the first conductive layer 21 to the intermediate layer outer peripheral surface 112. With reference to FIG. 3, two of the first internal circuits 22 are located between the bottom portion of the intermediate layer assembly and the bottom layer top surface 121, and are diagonally opposite to each other; while the other two of the first internal circuits 22 are located between the top portion of the intermediate layer assembly 11 and the top layer bottom surface 131, and are diagonally opposite to each other.

The second conductive unit 3 is made of metal, and includes at least one second conductive layer 31 disposed in the bottom groove 124 and having a downward concave shape, and at least one second internal circuit 32 connected to the second conductive layer 31. In this embodiment, the second conductive layer 31 covers the groove surrounding wall 122, the groove bottom wall 123 and a portion of the bottom layer top surface 121. Further, the second conductive unit 3 includes two second internal circuits 32 connected to the second conductive layer 31 that extends to and that covers the groove bottom wall 123. The second internal circuits 32 extend from the second conductive layer 31 at said groove bottom wall 123 to the bottom layer outer peripheral surface 120, and are diagonally opposite to each other. Specifically, the second internal circuits 32 are embedded between two raw ceramic blanks 100 that form the bottom layer assembly 12, as shown in FIG. 4.

The third conductive unit 4 is made of metal, and includes at least one third conductive layer 41 disposed in the top groove 134 and having an upward concave shape, and at least one third internal circuit 42 connected to the third conductive layer 41 and extending from the third conductive layer 41 to the top layer outer peripheral surface 130. In this embodiment, the third conductive layer 41 covers the groove surrounding wall 132, the groove bottom wall 133 and a portion of the top layer bottom surface 131. Further, the third conductive unit 4 includes two third internal circuits 42 connected to the third conductive layer 41 that extends to and that covers the groove bottom wall 133. The third internal circuits 42 extend from the third conductive layer 41 to the top layer outer peripheral surface 130, and are diagonally opposite to each other. Specifically, the third internal circuits 42 are embedded between two raw ceramic blanks 100 that form the top layer assembly 13, as shown in FIG. 4. Extending direction of the third internal circuits 42 is similar to that of the second internal circuits 32.

With reference to FIGS. 1, 3 and 4, the external electrode unit 5 is disposed on an outer surface of the ceramic body 1, and includes four first external electrodes 51 connected to the first internal circuits 22, and three second external electrodes 52, 52′, 52″. Each of the first external electrodes 51 has a cubic shape. The second external electrode 52 has an elongated cubic shape, and is connected to one of the second external circuits 32 and a corresponding one of the third external circuits 42. The second external electrode 52′ has a cubic shape, and is connected to the other one of second external circuits 32. The second external electrode 52″ also has a cubic shape, and is connected to the other one of third external circuits 42. The first and second external electrodes 51, 52, 52′, 52″ are disposed on corners of the ceramic body 1. Each of the first and second external electrodes 51, 52, 52′, 52″ covers three planes of a corresponding corner of the ceramic body 1. Further, the second external electrode 52 helps determine the direction of the sensor switch 200 from the outside and to connect in series the first and second conductive units 2, 3.

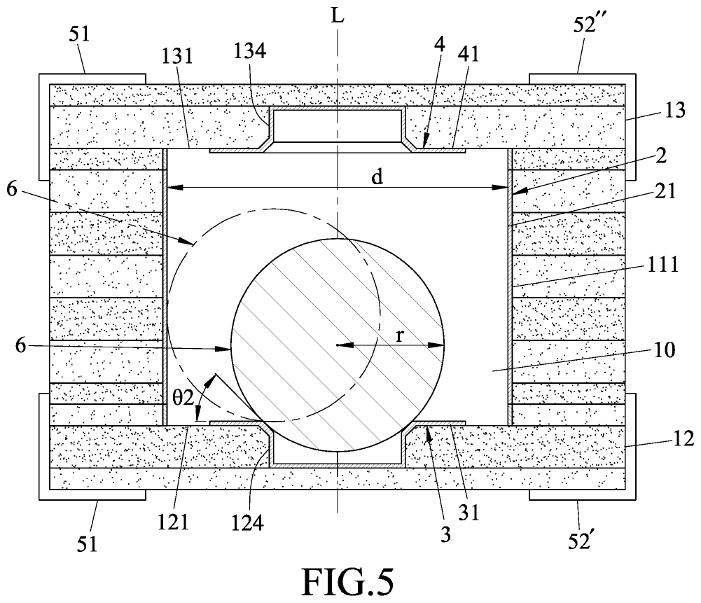

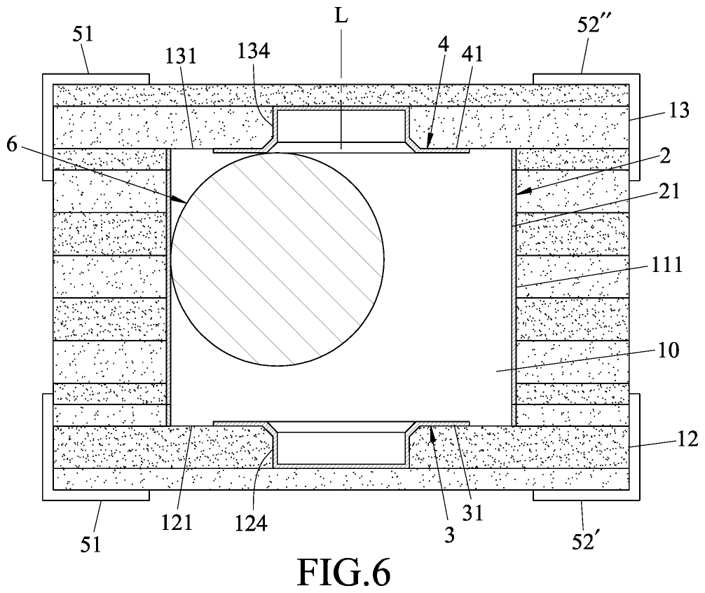

The conductive member 6 is rollably disposed in the chamber 10, and is movable between a first closed circuit position, as shown in imaginary line in FIG. 5, a second closed circuit position symmetrical to the first closed circuit position in a top-bottom direction, as shown in FIG. 6, and an open circuit position, as shown in solid line in FIG. 5. When the conductive member 6 is in the first closed circuit position, the first conductive layer 21, the conductive member 6 and the second conductive layer 31 form a current path. When the conductive member 6 is in the second closed circuit position, the first conductive layer 21, the conductive member 6 and the third conductive layer 41 form a current path. When the conductive member 6 is in the open circuit position, the first conductive layer 21, the conductive member 6 and the second conductive layer 31 do not form a current path; or, the first conductive layer 21, the conductive member 6 and the third conductive layer 41 do not form a current path. Further, when the ceramic body 1 is placed in a normal and horizontal position (that is, the bottom layer assembly 12, the intermediate layer assembly 11 and the top layer assembly 13 are arranged in the bottom-to-top direction), the conductive member 6 is limited by the second conductive layer 31 and is positioned at the open circuit position; and, when the ceramic body 1 is turned upside down and is placed horizontally, the conductive member 6 is limited by the third conductive layer 41 and is positioned at the open circuit position.

In this embodiment, the conductive member 6 has a spherical shape and a radius of r, while the chamber 10 has a cylindrical shape. Further, the conductive member 6 has a maximum rolling distance of d in the chamber 10 perpendicular to the axis (L), and 3r<d<4r. In other implementations, the conductive member 6 may be cylindrical, while the chamber 10 maybe rectangular, but are not limited thereto. Moreover, in this embodiment, when the conductive member 6 rolls from the bottom groove 124 to the bottom layer top surface 121 (or from the top groove 134 to the top layer bottom surface 131 when in the inverted position), the roll angle (θ2) thereof is 45°, but is not limited thereto.

To use the sensor switch 200, the sensor switch 200 is first soldered to a circuit board (not shown) using the first and second external electrodes 51, 52, 52′, 52″. Through the disposition of the first and second external electrodes 51, 52, 52′, 52″, the sensor switch 200 can be soldered to the circuit board in different directions according to the requirements of a user or a manufacturer.

In use, when the ceramic body 1 is placed in the normal and horizontal position, the conductive member 6 is positioned on the chamfered portion (122b) of the bottom groove 124 and is in contact only with the second conductive layer 31. At this time, the conductive member 6 is in the open circuit position (see the solid line in FIG. 5), and will not form a current path. When the ceramic body 1 is tilted or vibrated, the conductive member 6 will move away from the chamfered portion (122b) of the bottom groove 124 and simultaneously contact the first conductive layer 21 and the second conductive layer 31 to shift the sensor switch 200 to the first closed circuit position (see the imaginary line in FIG. 5), in which the first conductive layer 21, the conductive member 6 and the second conductive layer 31 form a current path, thereby achieving a sensing effect. Since the structure of this embodiment is symmetrical in the top-bottom direction, when the sensor switch 200 is turned upside down, it can similarly achieve the sensing effect.

Additionally, because the the conductive member 6 has a radius of r and a maximum rolling distance of d perpendicular to the axis (L), and 3r<d<4r, this can effectively reduce the overall volume of the sensor switch 200 and simultaneously prevent excessive sensitivity thereof.

In other implementations, the sensor switch 200 may include two or more conductive members 6. For example, two conductive members 6 of smaller radius are together received in the chamber 10. When the ceramic body 1 is placed horizontally, the conductive members 6 are positioned in the bottom groove 124 and are in contact only with the second conductive layer 31, thereby placing the sensor switch 200 in the open circuit position.

With reference to FIGS. 3, 4 and 6, it should be noted that this embodiment is made by multilayer ceramics (MLC) technology. A manufacturing process of the sensor switch 200 of this embodiment involves the following steps:

Step 1: preparing a plurality of raw ceramic blanks 100 made from inorganic ceramic materials and forming holes in the raw ceramic blanks 100 by machining;

Step 2: disposing metal materials, such as silver, gold, palladium, copper, nickel, or alloys thereof, on corresponding surfaces of the raw ceramic blanks 100 by applying conductive adhesive to a stencil, a steel plate, or an ink jet, or by alternately using electroplating, chemical plating, or sputtering so as to form the first conductive unit 2, the second conductive unit 3 and the third conductive unit 4;

Step 3: stacking two raw ceramic blanks 100 one above the other to form the bottom layer assembly 12, stacking eight raw ceramic blanks 100 one above the other to form the intermediate layer assembly 11, and stacking two raw ceramic blanks 100 one above the other to form the top layer assembly 13;

Step 4: stacking together the bottom layer assembly 12 and the intermediate layer assembly 11, and then hot pressing them to form an integral body using the method of hot water pressure equalization, and also hot pressing the two raw ceramic blanks 100 of the top layer assembly 13 using the method of hot water pressure equalization to form one body;

Step 5: cutting the stacked bottom and intermediate layer assemblies 12, 11 to a desired size, and cutting the top layer assembly 13 to a size similar to that of the stacked bottom and intermediate layer assemblies 12, 11;

Step 6: raising the ambient temperature to between 400° C. and 600° C. at a slow heating rate to heat the raw ceramic blanks 100 after being cut and to burn and crack the polymer additives added to the raw ceramic blanks 100 during pulping, then the ambient temperature is raised to between 800° C. and 900° C. to densify the raw ceramic blanks 100 and remove holes, and sintering the raw ceramic blanks 100 to form the stacked bottom and intermediate layer assemblies 12, 11 into one body and the top layer assembly 13 as another body;

Step 7: disposing metal materials (such as gold, alloy, etc.) by electroplating, sputtering or coating on corresponding surfaces of the first conductive unit 2, the second conductive unit 3 and the third conductive unit 4;

Step 8: placing the conductive member 6 in the chamber 10 defined by the stacked bottom and intermediate layer assemblies 12, 11, then coating an adhesive material, such as resin, glass, etc., on a junction of the top layer assembly 13 and the intermediate layer assembly 11, and irradiating or baking with UV light to raise the ambient temperature to between 300° C. and 500° C. to cure the adhesive material, thereby adhering integrally the top layer assembly 13 to the intermediate layer assembly 11 to form the ceramic body 1; and

Step 9: disposing metal materials, such as silver, gold, palladium, copper, nickel, or other alloys, by electroplating, sputtering or coating on an outer surface of the ceramic body 1 to form the first and second external electrodes 51, 52, 52′, 52″ of the external electrode unit 5.

Moreover, after step 2, the raw ceramic blanks 100 with the disposed metal materials may first be bonded together to form a block or plural blocks, after which the sintering step is employed to form the block or plural blocks, followed by coating adhesive materials on the blocks. After heat treatment, they are formed into the ceramic body 1. The making of the ceramic body 1 is not limited to the aforesaid steps.

Additionally, the order of the steps of the manufacturing process of the sensor switch 200 may be changed according to the requirements, or may be replaced with other manufacturing method, and is not limited to what is disclosed herein.

Through the aforesaid description, the advantages of this embodiment can be summarized as follows:

1. Through the ceramic body 1 which is made from a plurality of raw ceramic blanks 100 that are sintered after being stacked, and with the first, second and third conductive units 2, 3, 4 being made of metal materials disposed on the raw ceramic blanks 100, the overall volume of the sensor switch 200 can break through the minimum volume limit of the traditional switch made of plastic, can obtain a more streamlined structure and a smaller volume, and can achieve a good sealing effect, so that the first to third conductive units 2, 3, 4 cannot be easily damaged by moisture.

2. With the groove surrounding wall 122 having the chamfered portion (122b), an adhering area of the second conductive layer 31 can be increased to prevent falling off of the metal materials and affect the sensing function. The top layer assembly 13 is symmetrical to the bottom layer assembly 12 in structure, so that it also has the same effect.

3. By using the relationship of the radius (r) and the maximum rolling distance (d) of the conductive member 6 in the chamber 10 perpendicular to the axis (L) as 3r<d<4r, the overall volume of the sensor switch 200 can be effectively reduced while avoiding its excessive sensivity.

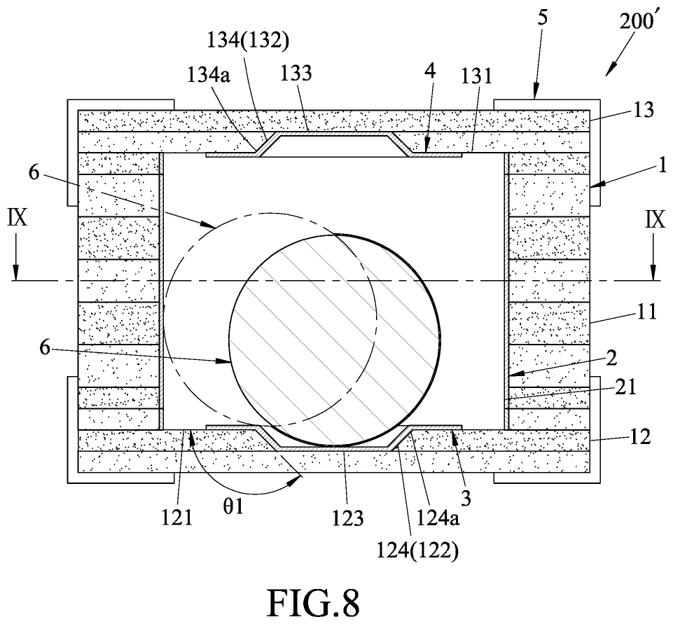

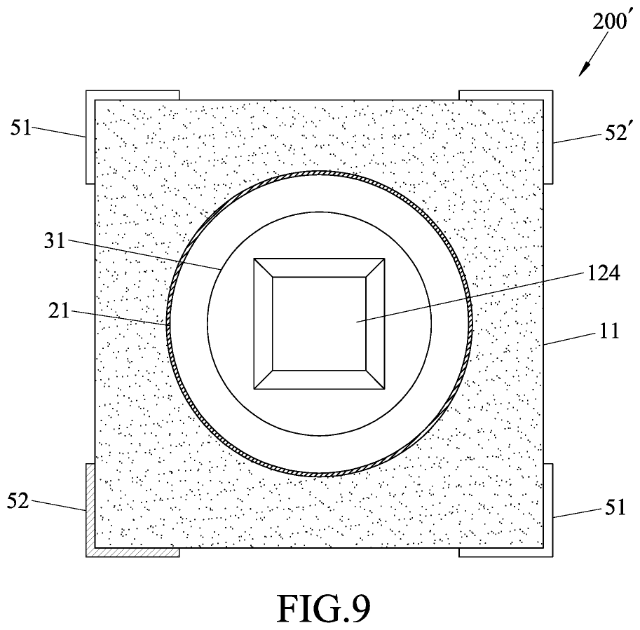

Referring to FIGS. 8 and 9, the second embodiment of the sensor switch 200′ according to this disclosure is shown to be similar to the first embodiment. The second embodiment differs from the first embodiment in that the groove surrounding wall 122 of the bottom groove 124 is inclined outwardly with respect to the groove bottom wall 123 and and defines an included angle (θ1) with the bottom layer top surface 121, and the groove surrounding wall 132 of the top groove 134 is also inclined outwardly with respect to the groove bottom wall 133 and defines an included angle with the top layer bottom surface 131 which is similar to the included angle (θ1). The included angle (θ1) is an obtuse angle. Further, the cross section of each of the bottom groove 124 and the top groove 134 perpendicular to the axis (L) is square.

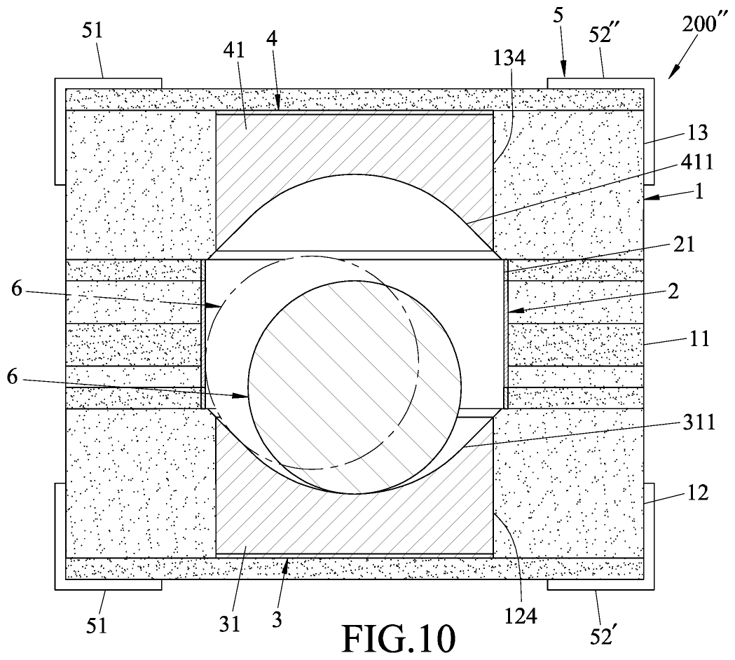

Referring to FIG. 10, the third embodiment of the sensor switch 200″ according to this disclosure is shown to be similar to the first embodiment. However, in this embodiment, the second conductive layer 31 of the second conductive unit 3 is filled in the bottom groove 124, and has a top surface 311 configured to contact the conductive member 6. The top surface 311 has a curved shape that curves away from the chamber 10. Further, the third conductive layer 41 of the third conductive unit 4 is filled in the top groove 134, and has a bottom surface 411 configured to contact the conductive member 6. The bottom. surface 411 has a curved shape that curves away from the chamber 10.

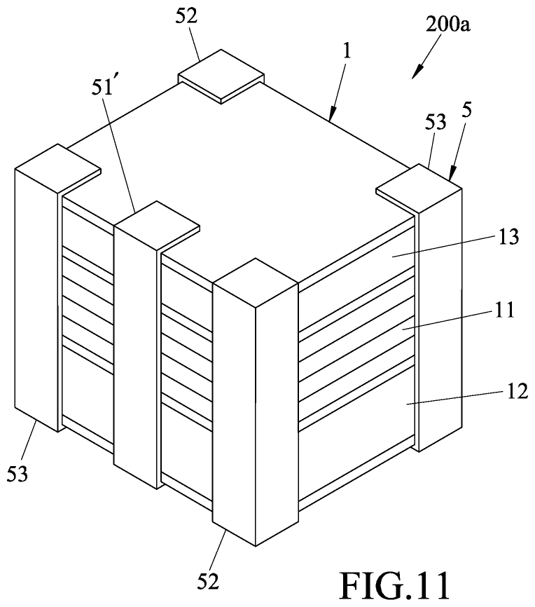

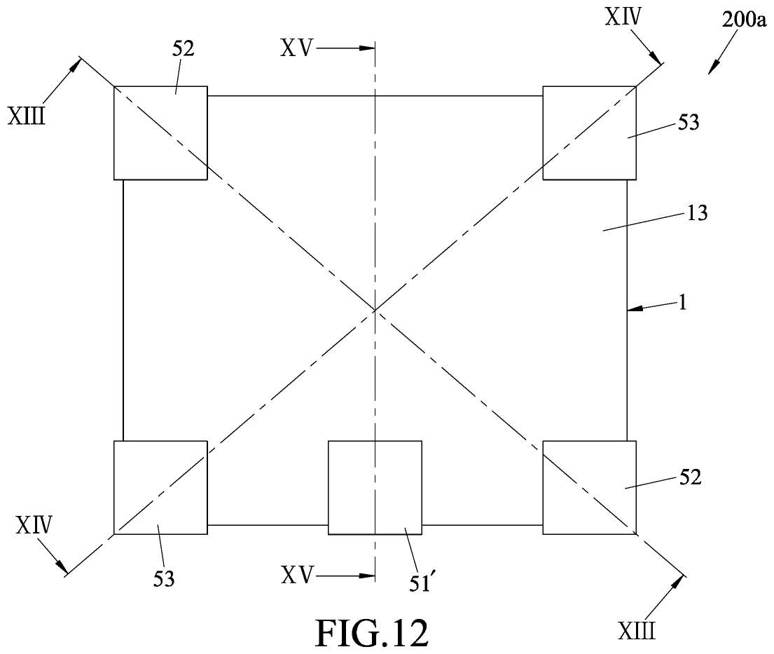

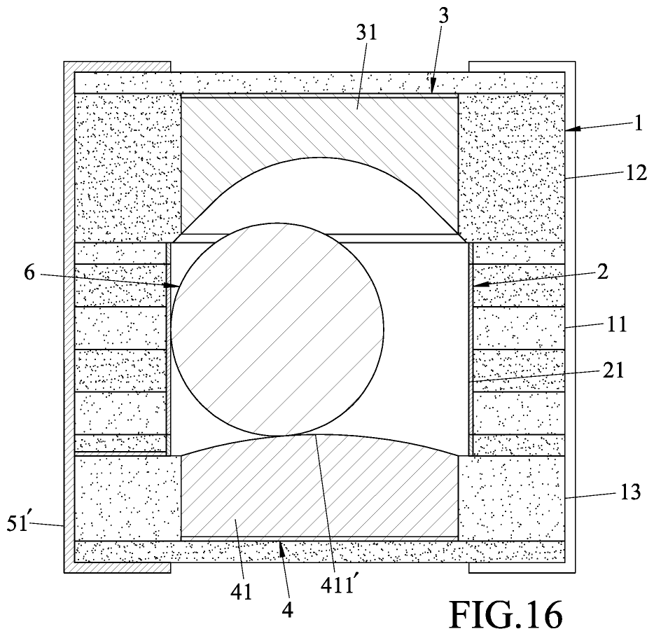

Referring to FIGS. 11 to 17, the fourth embodiment of the sensor switch (200a) according to this disclosure is shown to be similar to the third embodiment. However, in this embodiment, the bottom surface 411′ of the third conductive layer 41 of the third conductive unit 4 has a curved shape that curves toward the chamber 10. When the ceramic body 1 is turned upside down and is placed horizontally, the conductive member 6 is limited by the bottom surface 411′ and is positioned at the second closed circuit position, as best shown in FIG. 16.

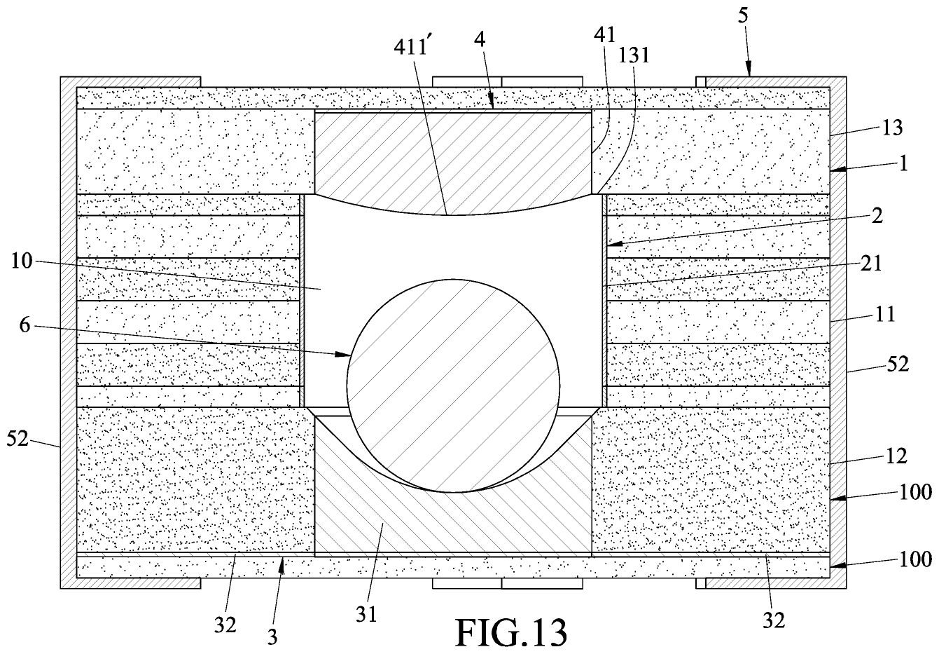

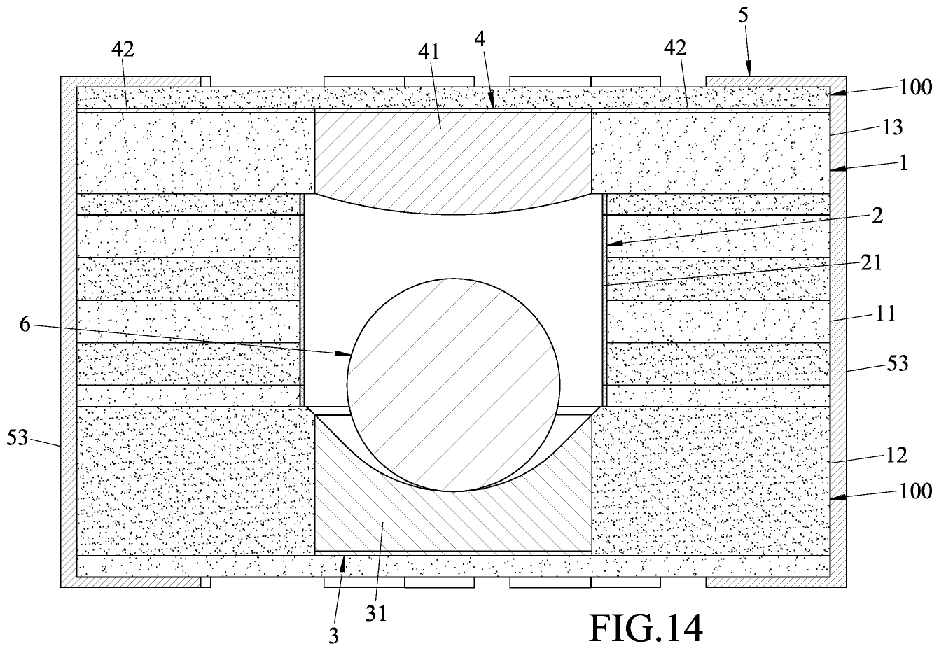

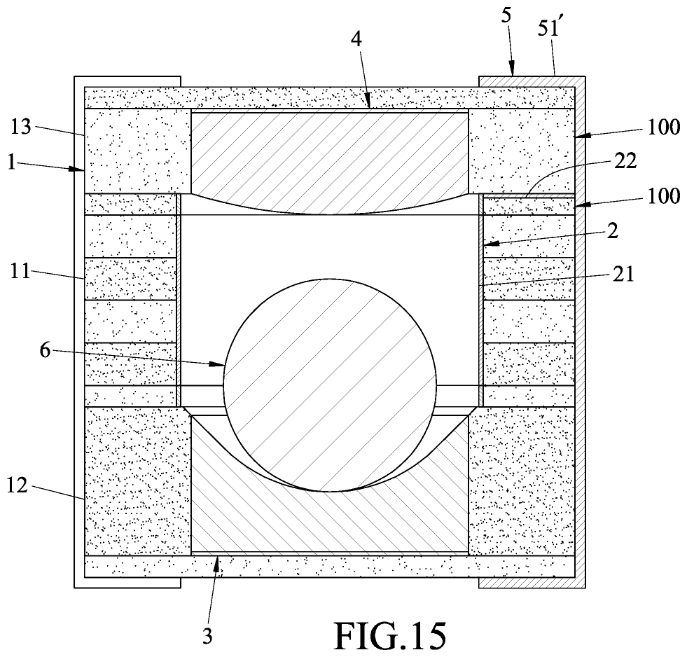

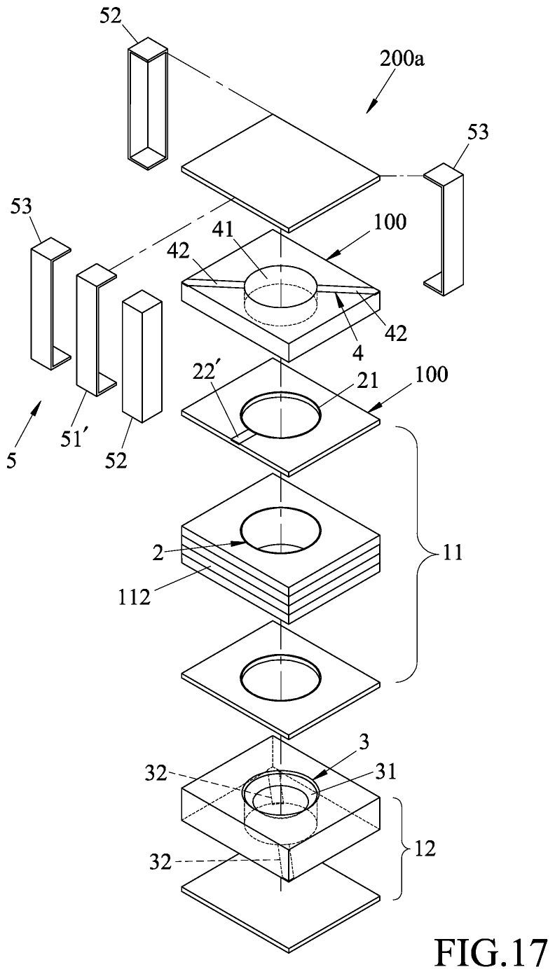

Further, in this embodiment, the first internal circuit 22′ (see FIG. 17) of the first conductive unit 2 extends radially from the first conductive layer 21 to the intermediate layer outer peripheral surface 112, and the first external electrode 51′ of the external electrode unit 5 has a U-shaped configuration with an intermediate portion connected to the first internal circuit 22′, as shown in FIG. 15. The external electrode unit 5 includes two second external electrodes 52 disposed on two corners of the ceramic body 1. The second external electrodes 52 are diagonally opposite to each other, and are respectively connected to the second internal circuits 32 of the second conductive unit 3, as shown in FIG. 13. The external electrode unit 5 further includes two third external electrodes 53 disposed on the other two corners of the ceramic body 1 and diagonally opposite to each other. The structure of each third external electrode 53 is similar to that of the second external electrode 52. The third external electrodes 53 are respectively connected to the third internal circuits 42 of the third conductive unit 4, as shown in FIG. 14. Each of the second and third external electrodes 52, 53 extends from a bottom portion of the bottom layer assembly 12 to a top portion of the top layer assembly 13. The first external electrode 51′ is located between one of the second external electrodes and a corresponding one of the third external electrodes 53.

With reference to FIGS. 13 and 14, through the connection of the second internal circuits 32 with the respective second external electrodes 52 and the connection of the third internal circuits 42 with the respective third external electrodes 53, in cooperation with the second and third conductive layers 31, 41, the sensor switch (200a) can effectively detect the state of the ceramic body 1 before and after being turned upside down.

In summary, with the ceramic body 1 being made from a plurality of raw ceramic blanks 100 that are sintered after being stacked, and with the first to third conductive units 2, 3, 4 being made of metal materials disposed on the raw ceramic blanks 100, the sensor switch (200, 200′, 200″, 200a) of this disclosure can be integrated to effectively reduce components, so that the overall volume thereof can break through the minimum volume limit of the traditional switch made of plastic, thereby obtaining a more streamlined structure and a smaller volume. Moreover, the sensor switch (200, 200′, 200″, 200a) can simultaneously achieve a good tight seal effect, so that the first to third conductive units 2, 3, 4 are not easily damaged by moisture. Therefore, the object of this disclosure can indeed be achieved.

In the description above, for the purposes of explanation, numerous specific details have been set forth in order to provide a thorough understanding of the embodiment(s). It will be apparent, however, to one skilled in the art, that one or more other embodiments maybe practiced without some of these specific details. It should also be appreciated that reference throughout this specification to “one embodiment,”“an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A sensor switch comprising:
a ceramic body made from a plurality of raw ceramic blanks that are sintered after being stacked, said ceramic body including an intermediate layer assembly, a bottom layer assembly disposed on a bottom portion of said intermediate layer assembly, and a top layer assembly disposed on a top portion of said intermediate layer assembly and opposite to said bottom layer assembly, wherein said intermediate layer assembly, said bottom layer assembly and said top layer assembly cooperatively define a chamber, said intermediate layer assembly having an intermediate layer inner peripheral surface facing said chamber, and an intermediate layer outer peripheral surface opposite to said intermediate layer inner peripheral surface, said bottom layer assembly having a bottom layer top surface connected to said bottom portion of said intermediate layer assembly and facing said chamber, a bottom groove indented inwardly from said bottom layer top surface and communicating with said chamber, and a bottom layer outer peripheral surface connected to an outer periphery of said bottom layer top surface;
a first conductive unit made of metal and including a first conductive layer disposed on and covering said intermediate layer inner peripheral surface, and at least one first internal circuit connected to said first conductive layer and extending from said first conductive layer to said intermediate layer outer peripheral surface;
a second conductive unit made of metal and including at least one second conductive layer disposed in said bottom groove, and at least one second internal circuit connected to said second conductive layer and extending from said second conductive layer to said bottom layer outer peripheral surface; and
a conductive member rollably disposed in said chamber and movable between a first closed circuit position and an open circuit position;
when said conductive member is in the first closed circuit position, said first conductive layer, said conductive member and said second conductive layer form a current path;
when said conductive member is in the open circuit position, said first conductive layer, said conductive member and said second conductive layer do not form a current path; and
when said ceramic body is placed in a normal and horizontal position, in which said bottom layer assembly, said intermediate layer assembly and said top layer assembly are arranged in a bottom-to-top direction, said conductive member is limited by said second conductive layer and is positioned at the open circuit position.

2. The sensor switch as claimed in claim 1, wherein said bottom groove is defined by a groove surrounding wall connected to said bottom layer top surface, and a groove bottom wall connected to said groove surrounding wall opposite said bottom layer top surface.

3. The sensor switch as claimed in claim 2, wherein said second conductive layer covers said bottom layer top surface, said groove surrounding wall and said groove bottom wall.

4. The sensor switch as claimed in claim 2, wherein said groove surrounding wall and said bottom layer top surface define an included angle therebetween, said included angle being an obtuse angle.

5. The sensor switch as claimed in claim 1, wherein said second conductive layer is filled in said bottom groove, and has a top surface configured to contact said conductive member, said top surface of said second conductive layer having a curved shape that curves away from said chamber.

6. The sensor switch as claimed in claim 3, wherein said at least one second internal circuit is embedded between said raw ceramic blanks that form said bottom layer assembly and is connected to said second conductive layer that extends to said groove bottom wall, said at least one second internal circuit extending from said second conductive layer to said bottom layer outer peripheral surface.

7. The sensor switch as claimed in claim 5, wherein said at least one first internal circuit is located between said intermediate layer assembly and said bottom layer assembly.

8. The sensor switch as claimed in claim 5, wherein said at least one first internal circuit is located between said intermediate layer assembly and said top layer assembly.

9. The sensor switch as claimed in claim 1, wherein:
said conductive member has a spherical shape and a radius of r;
said chamber has an axis parallel to the bottom-to-top direction; and
said conductive member has a maximum rolling distance of d in said chamber perpendicular to the axis, and 3r<d<4r.

10. The sensor switch as claimed in claim 1, wherein:
said top layer assembly has a top layer bottom surface connected to said top portion of said intermediate layer assembly and facing said chamber, a top groove indented inwardly from said top layer bottom surface, and a top layer outer peripheral surface connected to an outer periphery of said top layer bottom surface;
said sensor switch further comprises a third conductive unit made of metal and including at least one third conductive layer disposed in said top groove, and at least one third internal circuit connected to said third conductive layer and extending from said third conductive layer to said top layer outer peripheral surface;
said conductive member is further movable in said chamber between a second closed circuit position and the open circuit position;
when said conductive member is in the second closed circuit position, said first conductive layer, said conductive member and said third conductive layer form a current path;
when said conductive member is in the open circuit position, said first conductive layer, said conductive member and said third conductive layer do not form a current path; and
when said ceramic body is turned upside down and is placed horizontally, said conductive member is limited by said third conductive layer and is positioned at the open circuit position.

11. The sensor switch as claimed in claim 10, wherein:
said third conductive layer has a bottom surface configured to contact said conductive member, said bottom surface of said third conductive layer having a curved shape that curves toward said chamber;
when said conductive member is in the open circuit position, said first conductive layer, said conductive member, said second conductive layer and said third conductive layer do not form a current path; and
when said ceramic body is turned upside down and is placed horizontally, said conductive member is limited by said bottom surface of said third conductive layer and is positioned at the second closed circuit position.

12. The sensor switch as claimed in claim 1, wherein said first and second conductive units are made by disposing metal materials on corresponding surfaces of said raw ceramic blanks by applying conductive adhesive to a stencil, a steel plate, or an ink jet, or by alternately using electroplating, chemical plating, or sputtering.
